(19) United States
(12) Patent Application Publication
(10) Pub. No.: US 2014/0310786 A1
(43) Pub. Date: Oct. 16, 2014

(54) INTEGRATED INTERACTIVE MESSAGING AND BIOMETRIC ENROLLMENT, VERIFICATION, AND IDENTIFICATION SYSTEM

(71) Applicant: IMAGEWARE SYSTEMS, INC., SAN DIEGO, CA (US)

(72) Inventor: David Harding, Clackamas, OR (US)

(73) Assignee: IMAGEWARE SYSTEMS, INC., SAN DIEGO, CA (US)

(21) Appl. No.: 14/254,849

(22) Filed: Apr. 16, 2014

Related U.S. Application Data
(60) Provisional application No. 61/812,640, filed on Apr. 16, 2013.
(60) Provisional application No. 61/812,654, filed on Apr. 16, 2013.
(60) Provisional application No. 61/812,697, filed on Apr. 16, 2013.

(51) Int. Cl. H04L 29/06

(52) U.S. Cl. CPC H04L 63/0861
USPC 726/5

(57) ABSTRACT

The present invention provides an integrated interactive messaging system having a biometric engine in order to enhance security of interactive transactions or communications, while also expanding interactive capabilities. The biometric engine is operatively coupled to an interactive messaging system through a suitable network connection. The integrated system includes one or more biometric clients, as well as one or more client application servers. A rules engine is in communication or incorporated within the interactive messaging system.

### CROSS-REFERENCE TO RELATED APPLICATIONS

The present application also claims priority to U.S. Provisional Patent Application No. 61/812,640, filed on Apr. 16, 2013, and entitled “System for Integrating Interactive Messaging with Biometric Verification;” U.S. Provisional Patent Application No. U.S. Provisional 61/812,654, filed on Apr. 16, 2013, and entitled “System for Integrating Interactive Messaging with Biometric Enrollment;” and U.S. Provisional Patent Application No. 61/812,697, filed on Apr. 16, 2013, and entitled “System for Integrating Interactive Messaging with Biometric Identification;” the disclosures of which are all incorporated by reference in their entireties herein.

### BACKGROUND OF THE INVENTION

1. Field of Invention

The present disclosure relates generally to text messaging and biometric systems, and more particularly, to an integrated system that combines interactive messaging with biometric enrollment, verification, and identification.

2. Description of Related Art

An interactive messaging system provides an interactive communication process between one or more clients (or user devices) and one or more client applications or client application servers. An interactive messaging system includes a framework that provides core services, which can be utilized to send interactive messages to clients. Interactive messages sent to clients typically include a question along with action options for the client to choose from. Each action option may correspond to a pre-assigned response keys (whether physical or virtual) or other user gestures from a client device. U.S. Pat. Nos. 7,321,920; 7,340,503; 7,353,258; and 8,117,287, which are all incorporated by reference in their entireties herein, disclose an exemplary interactive messaging system. An interactive message system can be utilized in many ways including proposing a question or action to a client and receiving client's response; to broker an event such as a call, a conference call, a game, among others; as an interactive learning tool; as an interactive remainder; and to receive authorization for a specified event or purchasing of an item, among others.

While interactive messaging system proves to be useful to clients in the sense of providing a variety of interactive applications, enhanced security is desired within an interactive messaging platform in order to prevent fraudulent actions. Different forms of informational security include encrypted messages, as well as the traditional usernames and passwords, but these forms of security may be decrypted or may be stolen, thereby, exposing several vulnerabilities.

A biometric engine controls different components of a biometric system. The biometric engine facilitates the enrollment, capture, extraction, comparison and matching of biometric data from a user, i.e., client. The biometric engine provides authentication services to client applications and clients, where the identity of one or more clients may be verified or identified in a determined population using one or more biometric modalities, e.g., face, finger, retina, palm, voice, etc. A score or probability may be returned by the biometric engine to indicate successful or failed verification or identification without having to send personal information. A biometric engine may also be employed for identification. U.S. Pat. Nos. 7,298,873; 7,362,884; 7,596,246; and 7,606,396; which are all incorporated by reference in their entireties herein, disclose exemplary biometric systems and biometric engines.

It is desirable to incorporate a biometric engine into an interactive messaging system in order to enhance security and expand the interactive capabilities of the system.

### SUMMARY OF THE INVENTION

The present invention provides an integrated interactive messaging system having a biometric engine in order to enhance security of interactive transactions or communications, while also expanding interactive capabilities. The biometric engine is operatively coupled to an interactive messaging system through a suitable network connection. The integrated system includes one or more biometric clients, as well as one or more client application servers. A rules engine is in communication or incorporated within the interactive messaging system.

In an embodiment of the invention, the interactive messaging system comprises an application framework that allows interactive communication with one or more clients. This application framework comprises four core services exposed via web services, where these core services include data services, messaging services, brokering services, and learning services. These core services in the application framework are used by a client application server to send or push interactive messages to one or more clients. Interactive messages can include a question for verifying or authorizing a transaction, along with corresponding action options that can be selected by the client when client receives the interactive message. Clients can include suitable computing devices capable of receiving or responding interactive messages, as well as capturing one or more biometrics of different modalities. The biometric engine comprises a query router operatively connected to one or more query engines, where these query engines are associated with one or more biometric data caches that store biometric templates of clients.

In an embodiment of the invention, an enrollment process within the integrated system begins when an application server requests the formulation of an interactive message to the interactive message system in order to confirm or authorize a transaction. The interactive message system sends this interactive message to one or more clients, which select an action option in response to the question included in the interactive message. The interactive message system receives the response from the client and requests biometric authentication before validating the response. A rules engine determines if biometric templates are available in the biometric engine for authenticating the client. If biometrics are available, then enrollment process concludes. If there are biometrics available for that particular client, then the enrollment process continues where the rules engine selects one or more types of biometrics to be enrolled according to the capabilities of the client's device. After the rules engine selects one or more types of biometrics to be enrolled, rules engine requests the creation of an enroll interactive message to the interactive message system with a list of biometrics required from client. Subsequently, the interactive message system formulates and sends another interactive message to the client requesting enrollment of corresponding biometrics. Client responds to the message by capturing and sending corresponding biometric probes using his/her computing device. The interactive message system receives these biometric probes and sends them to the biometric engine for enrollment. The interactive message system associates the captured biometric probes with client profile stored in a database, while the biometric engine converts the biometric probes into corresponding biometric templates that are stored in one or more data caches. With enrolled biometrics available in biometric engine, the interactive message system continues and processes the action requested by client.

In another embodiment of the invention, a verification process begins when an application server requests the formulation of an interactive message to the interactive message system in order to confirm or authorize a transaction. The interactive message system sends this interactive message to one or more clients, which selects an action option in response to the question included in the interactive message. The interactive message system receives the response from the client and requests biometric authentication before validating the response. A rules engine determines if biometric templates are available in the biometric engine for authenticating the client and subsequently determines if the computing device that it is being used by the client provides situational support. For example, rules engine employs situational/conditional logic to determine if the client's computing device is capable of capturing biometric probes and also determines if the captured biometric probes are within certain quality standards for allowing suitable biometric verification. After the preferred conditions for biometric authentication are determined, the interactive message system sends another interactive message requesting the capturing of suitable biometric probes. Client responds by sending one or more biometric probes to the interactive message system, which sends those biometric probes to the biometric engine for verification. A query router within the biometric engine distributes the biometric probes to corresponding query engines, which convert the biometric probes into biometric templates for comparison against biometric probes already stored in the biometric data caches. The result of this comparison is a score that indicates a probability of successful biometric matching. The biometric engine notifies a successful or failed biometric verification to the interactive message system, which subsequently denies or authorizes a transaction. The interactive message system sends another interactive message to notify the client and also includes options for additional action to continue or conclude the verification process.

In yet another embodiment of the invention, an identification process begins when a client requests a biometric identification of an individual among a determined population. The interactive message system receives the request from the client and establishes communication with a rules engine. Rules engine determines if computing device, used by client, supports biometric capturing of biometric probes. If computing device supports biometric capturing, the rules engine selects one or more types of biometrics to be captured by client, whereupon the interactive message system determines and formulates an interactive message with a list of biometrics required from client. Subsequently, client responds to the message by capturing and sending corresponding biometric probes using his/her computing device. The interactive message system receives these biometric probes and sends them to the biometric engine to be compared against previously enrolled biometric templates stored in a data cache. The biometric engine associates the captured biometric probes with corresponding biometric templates to obtain at least one or more match results. At least one score may be generated in the match results. Thereafter, the biometric engine determines if one or more of biometric scores generated meet a minimum threshold score to be added into a list of possible matches associated with identification credentials. Finally, the interactive message system sends another interactive message to client in order to send the response with a corresponding identity of the individual.

In an embodiment of the invention, an integrated interactive messaging system comprises: an interactive messaging server configured to communicate interactive messages to a client device used by a user; and a biometric engine to enroll, authenticate, or identify the user via one or more biometrics captured at the client device. The system is multi-modal in that one or more biometrics comprise two or more different biometrics. The biometric engine comprises a query router and two or more query engines, each query engine dedicated to one of the two or more different biometrics. The query router is configured to receive a request from the interactive messaging server to authenticate or identify the user and a first biometric probe and a second biometric probe, route the first biometric probe to a first query engine of the two or more query engines, and route the second biometric probe to a second query engine of the two or more query engines. The query router is also configured to receive a response from the first query engine and a response from the second query engine, wherein the response from the first query engine comprises an indication that authentication or identification of the first biometric probe was successful or unsuccessful, and the response from the second query engine comprises an indication that authentication or identification of the second biometric probe was successful or unsuccessful. The query router is further configured to send a response to the interactive messaging server, the response to the interactive messaging server comprising an indication that authentication or identification of the user was successful or unsuccessful. The response to the interactive messaging server can also include one or more biometric scores or a biometric fusion score. The request from the interactive messaging server to authenticate or identify the user is a service-oriented architecture (SOA) call. the biometric engine further comprises a first biometric data cache and a second biometric data cache, the first biometric data cache comprising a set of biometric templates of a first biometric type, the second biometric data cache comprising a set of biometric templates of a second biometric type, and the biometric engine is configured to never send the set of biometric templates of a first biometric type and the set of biometric templates of a second biometric type to the interactive messaging server.

In another embodiment of the invention, an integrated interactive messaging method is implemented at an interactive messaging server and comprises: communicating one or more interactive messages to a client device used by a user; and receiving one or more biometrics captured at the client device. The one or more biometrics comprises two or more different biometrics. The method further comprises sending a request to authenticate or identify the user and a first biometric probe and a second biometric probe to a biometric engine and receiving a response from the biometric engine indicating that authentication or identification of the user was successful or unsuccessful. The response comprises one or more biometric scores or a biometric fusion score.

The present invention integrates biometric authentication into interactive messaging, thereby, providing clients with secure and reliable transactions or communications. The disclosed enrollment process enables the integrated system to use enrolled biometric templates for performing verification and identification. The integrated system combines the capabilities of both an interactive messaging system and a biometric engine, including interactive communication, situational support and multimodal biometric operation, among others.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 illustrates a biometric engine according to an embodiment of the invention;

FIG. 2 illustrates an interactive messaging system according to an embodiment of the invention;

FIG. 3 illustrates an integrated interactive messaging system according to an embodiment of the invention;

FIG. 4 illustrates an enrollment process according to an embodiment of the invention;

FIG. 5 illustrates a verification process according to an embodiment of the invention; and

FIG. 6 illustrates an identification process according to an embodiment of the invention.

### DETAILED DESCRIPTION OF EMBODIMENTS

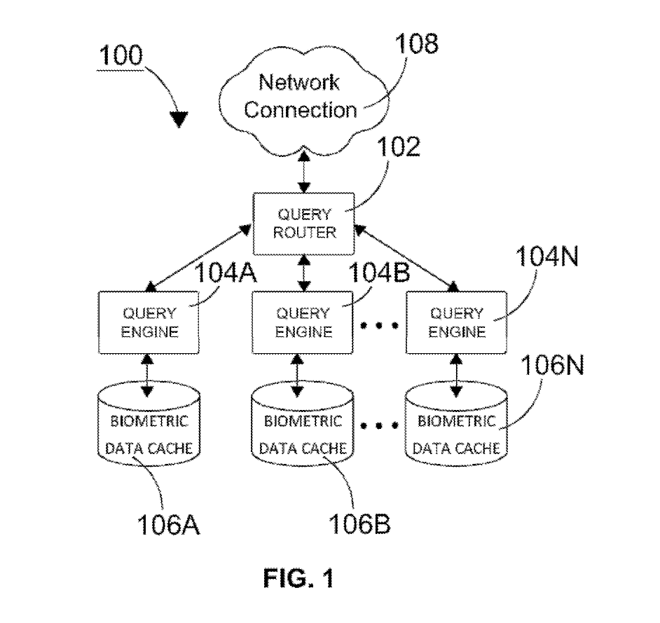

Preferred embodiments of the present invention and their advantages may be understood by referring to FIGS. 1-6, wherein like reference numerals refer to like elements. The descriptions and features disclosed herein can be applied to various interactive messaging systems, the identification and implementation of which are apparent to one of ordinary skill in the art. The features described herein are broadly applicable to any type of communications technologies and standards.

As used herein, the following terms have the following definitions:

“Biometric Verification” refers to authentication of an identity of a client using biometric data.

“Biometric Identification” refers to identify the identity of a person among a biometrically enrolled population.

“Biometric Capture” refers to using a biometric input device or system to capture biometric data in the form of images, templates, or other data forms.

“Biometric Probe” refers to any captured biometric that may be used to compare with or match against one or more prior biometric enrollments.

“Biometric Data” refers to information that may be used to verify or identify a person based on physical traits or behaviors. Biometric data includes, but is not limited to images of fingerprints, faces, irises, and any other binary data generated by biometric algorithms, the identification and implementation of which are apparent to one of ordinary skill in the art.

“Biometric template” refers to a piece of binary data generated by a biometric algorithm that is used to compare one biometric against another.

“Query engine” refers to a system capable of comparing biometric templates and returning a biometric score or a biometric fusion scores.

“Query router” refers to a system that manages and queues queries in a query engine.

“Biometric fusion score” is any probability score that multiple biometric enrollments of one or more biometric modalities match multiple biometric probes of the same modalities. The scores of each modality are normalized and combined (i.e., fused) to create a single probability score.

“Client” refers to a person having a computing device capable of receiving and responding interactive messages, and also capable of capturing one or more biometrics of different modalities.

“Interactive message” refers to an electronic message that may be sent via an interactive messaging system to one or more clients, where this interactive message may include a question and corresponding action options that may be selected by the client.

“Rules engine” refers to a software module that includes situational or conditional logic for determining if clients are capable of capturing suitable biometric probes or if suitable biometric templates for biometric authentication or identification are stored in a biometric engine.

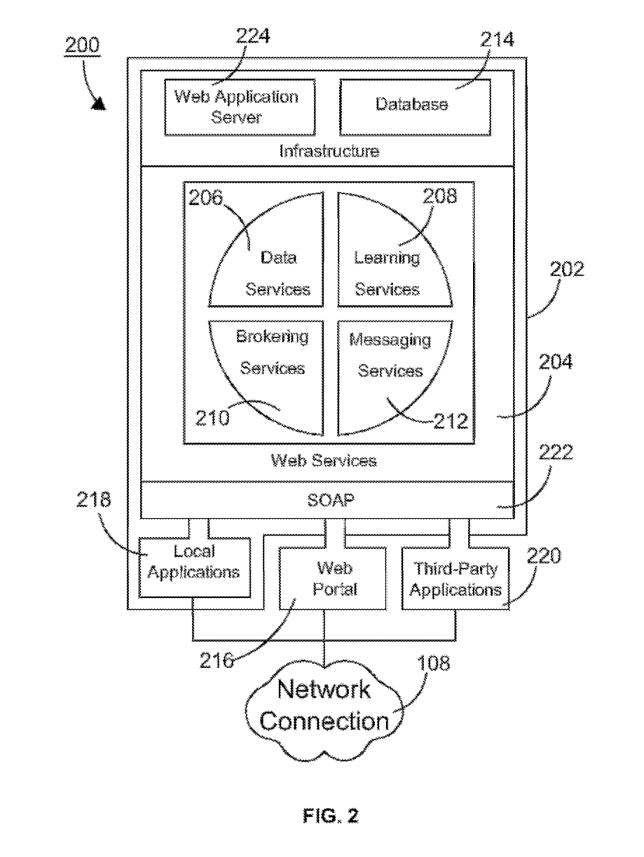

FIG. 1 illustrates a biometric engine 100 according to an embodiment of the invention. The biometric engine 100 comprises a query router 102, one or more query engines 104A-N, and one or more biometric data caches 106A-N. The query router 102 is operatively connected to a suitable network connection 108, which provides an operational connection at server level with an Interactive Messaging System (IMS) (shown in FIG. 2).

The query router 102 comprises a computer having installed thereon a suitable operating system and biometric software programmed according to the embodiments described herein. The query router 102 is associated with a demographic database (not shown) for storing demographic data which may run on a cloud-based database service, virtual machine or physical memory. The query router 102 is in communication with the one or more query engines 104A-N through a suitable internet protocol (IP) network. Each query engine 104 includes a computer having installed thereon a suitable operating and biometric software according to the embodiments described herein. Each query engine 104 is associated with a respective biometric data cache 106, which is implemented on a cloud-based database service, virtual machine or physical memory.

The query router 102 receives service-oriented architecture (SOA) calls from the IMS and then routes those requests to the appropriate query engines 104A-N, depending on the biometric type or work load on the query engines 104A-N. The query router 102 monitors the activities of the query engines 104A-N and combines their responses (success/fail) into a single SOA response, which is sent back to the IMS through the network connection 108. Each query engine 104 converts biometric probes into biometric templates. In an embodiment of the invention, a query engine 104 comprises a template data manager, which manages a respective biometric data cache 106 where biometric templates are stored and retrieved. A query engine 104 communicates with the query router 102 and may move biometric templates into and out of biometric data cache 106. A query engine 104 may also support one or more biometric data caches 106A-N.

The query router 102 may configure query engines 104A-N in a group for striped or mirrored operation. In striped operation, biometric templates are cached in a striped or distributed fashion across the query engines 104 of the group. Each query engine 104 caches only part of biometric templates of the group. The query router 102 may distribute the biometric templates to query engines 104 based upon a load balancing scheme that maintains the number of biometric templates cached by each query engine 104 approximately equal. Meanwhile, in the mirrored configuration, biometric templates are mirrored across the entire query engine 104 group. Each query engine 104 may cache every biometric template assigned to the group. In the mirrored configuration, the query router 102 instructs a single query engine 104 to execute a search without having to queue search requests.

FIG. 2 illustrates an interactive messaging system 200 according to an embodiment of the invention. The interactive messaging system 200 comprises an application framework 202 that facilitates interactive communication between one or more clients and a server implementing the interactive messaging system 200. The application framework 202 comprises four core services exposed via web services 204, where these core services include data services 206, messaging services 208, brokering services 210, and learning services 212. These core services in the application framework 202 may be used by a client application server to send or push interactive messages to one or more clients.

The data services 206 may store information, including client profiles, which determine if and when an interactive message is to be sent to the client. Client profiles are stored in a database 214. Information stored within the profiles can include an access control list that filters or blocks specific clients, photographs and sounds which may be included in the interactive message. Additional information in the profiles includes a priority profile where the client can specify the level of intrusion for receiving interactive messages by the interactive messaging system 200 (e.g., do not interrupt if on a call) and also may store identification and password information, frequently used response lists to be included in the message, a list of birthdays and anniversaries of friends and family and other holidays. Client profiles can be accessed through a web portal 216 allowing clients to update their profile. In addition, the web portal 216 may be used for connecting the interactive messaging system 200 with the biometric engine 100.

The messaging service 208 can push or send an interactive message to the computing device of a client. Before the message can be pushed or sent, messaging services 208 first determines if the computing device of the client is capable of receiving a pushed or sent message. If the computing device is capable of receiving the message, messaging services 208 converts the message into a format readable by the computing device. If the computing device is not capable of receiving a pushed or sent message, messaging services 208 may convert the message to a short message service (SMS) and send it as a SMS message. Furthermore, messaging services 208 are capable of formatting the message into a format that includes multimedia capabilities such as, but not limited to text, sound, graphics, video or a turn based interactive game.

The brokering services 210 manage the coordination of clients, and the delivery of interactive messages to the computing devices of the clients. Clients may have the option of re-scheduling the response of interactive messages to their computing devices by selecting a “snooze” feature. The “snooze” feature may terminate the interactive message and may schedule a future time when the message may be resent to the client. Once this feature is selected, the brokering services 210 resends the message at a later time such as in 10 minutes, 30 minutes, an hour or any other time specified by the client.

The learning services 212 are used to facilitate learning by sending or pushing study material, such as in the form of multiple choice questions, to clients, such as students. For example, vocabulary questions can be sent to the client when studying for the SAT®. A word with four possible definitions can be pushed or sent to the student's computing device. The learning services 212 accomplishes this by managing a process for the user learning new information including concept presentation, pre-testing, mastery drilling, final testing and follow up review.

When messaging protocols are used within the application framework 202, local applications 218 and third party applications 220 are allowed to talk to core services. The interactive messaging system 200 has assigned business policies, rules and required services in the application framework 202. The local applications 218 store the application logic and web services 204 using SOAP messaging 222 and instruct or trigger the construction and delivery of the interactive messages. Web services 204 share business logic, data and process through a programmatic interface across a network amongst the core services. Since web services 204 may not be tied to any one operating system or programming language, different applications from different sources communicate with each other without time consuming custom coding since all communication is in extensible markup language (XML) according to an embodiment of the invention. As a result, the web services 204 provide a platform for exposing or making accessible the core services to third party applications 220 using software that is running on different operating systems and devices, written using different programming languages and tools from multiple vendors, all potentially developed and deployed independently. As a result, an open architecture for third parties is created.

In the application framework 202, a web application server 224 is provided. The web application server 224 includes a software module that answers requests from clients, third parties and local applications 218. When answering a call, web services 204 looks up the requested information in a database 214. The database 214 may be used to store data, information and rules for pushing the interactive messages to a computing device. Upon receiving a call, the web application server 224 retrieves the information in database 214 via data services 206.

The application framework 202 sends various types of interactive messages. The various types of messages include, but are not limited to scheduling a meeting, sending a reminder, confirm or authorize a transaction, initiating a multi-player game on a computing device and interactive learning. In an embodiment of the invention, these interactive messages are composed by filling in a pre-formed template, in which the application framework 202 may send or push the messages to clients via a network connection 108.

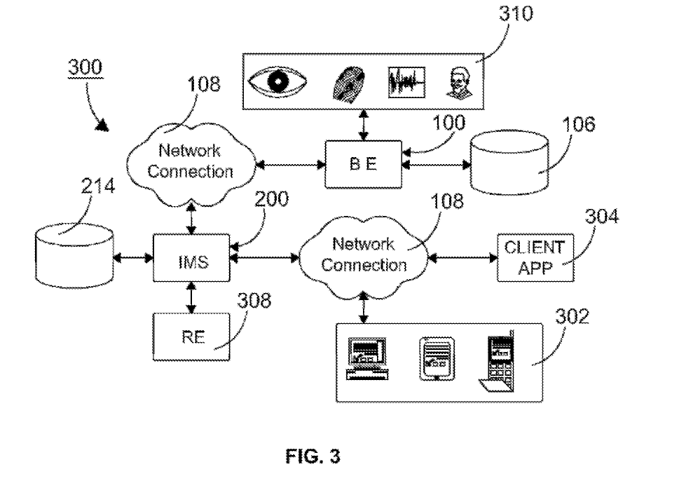

FIG. 3 illustrates an integrated interactive messaging system 300 according to an embodiment of the invention. The integrated interactive messaging system 300 combines operations of the biometric engine 100 with the interactive messaging system 200. The integrated system 300 comprises one or more clients 302 and one or more client application servers 304.

Clients 302 may include any type of computing device such as, but not limited to a desktop computer, a tablet computer, and smartphone, where these devices include a suitable operating system and a biometric capturing device. Specifically, client 302 includes a client software development kit (SDK) that collects and formats biometric data captured by the capture device for transmission to the interactive messaging system 200 and/or biometric engine 100 in the form of biometric probes. Clients 302 also include a software module capable of receiving and responding to interactive messages from the interactive messaging system 200, while also supporting biometric capture for user authentication and/or enrollment against biometric engine 100. Clients 302 are operatively connected with the interactive messaging system 200 through a suitable network connection 108, where such connection can be implemented through known methods such as, but not limited to cellular 3G, cellular 4G, Wi-Fi, WiMax, and landline broadband, among others, the identification and/or implementation of which are all apparent to one of ordinary skill in the art.

Client application server 304 includes a plurality of third-party applications, services, or resources made available to clients 302 through the interactive messaging system 200, where client application server 304 is operatively connected to the interactive messaging system 200 using the network connection 108. Optionally, the interactive messaging system 200 resides as part of a client application server 304, in which case, client application server 304 may communicate directly with client 302. The interactive messaging system 200 is operatively connected to the biometric engine 100 through network connection 108. The interactive messaging system 200 is associated with a database 214, which support services such as scheduling as described above.

In the integrated system 300, client application server 304 sends a request to the interactive messaging system 200 to prepare an interactive message, which may include options for obtaining any form of transaction confirmation or authorization. Subsequently, the interactive messaging system 200 sends an interactive message to one or more clients 302 based on the request from client application server 304. Client 302 may receive this interactive message and may be required to perform an initial action from a list of options available in the interactive message. The interactive message can be sent back to the interactive messaging system 200, where a rules engine 308 in communication with or integrated within the interactive messaging system 200 determines if biometric authentication of clients 302 is required to confirm or authorize initial action selected by clients 302. If biometric authentication is required, rules engine 308, based on conditional and/or situational logic, may select one or more biometric modalities to be used for client 302 authentication. This selection by rules engine 308 is performed according to the type of biometric modalities supported by the computing device being used by clients 302 and/or the type of biometric templates already enrolled in biometric data caches 106 of the biometric engine 100. Optionally, rules engine 308 may determine that no biometric authentication is required, in which case, the interactive messaging system 200 confirms or authorizes initial action selected by clients 302. In addition, rules engine 308 may apply conditional and/or situational logic to determine one or more biometric modalities suitable for working under specific conditions such as weather or environmental circumstances; quality or availability of biometric capturing device; history of authentication successes or failures; and/or user preferences.

After rules engine 308 determines one or more biometric modalities suitable for client 302 authentication, the interactive messaging system 200 sends another interactive message (or optionally as part of the original message) to client 302 requesting the capturing of the corresponding biometric probes. Client 302 captures and submits one or more biometric probes to the interactive messaging system 200 for subsequent distribution to biometric engine 100. In another embodiment, clients 302 may send one or more biometric probes directly to biometric engine 100 through a suitable network connection (not shown).

In biometric engine 100, biometric probes received from the interactive messaging system 200 are initially processed by query router 102, which distributes biometric probes to the appropriate query engine 104, depending on the biometric type or work load on the query engine 104. The query engine 104 in conjunction with the template data manager converts the biometric probe into a biometric template for comparison against previously stored biometric templates in one or more biometric data caches 106. The result of the comparison is a biometric score that represents a probability that the captured biometric probe is from the same person as the biometric template it is being compared against. Query engine 104 then returns the generated biometric score to query router 102, which sends a SOA response back to the interactive messaging system 200 indicating a successful or failed matching.

Based on the biometric matching process performed in the biometric engine 100, the interactive messaging system 200′ may authorize or deny transaction requested by client application 304, and subsequently, the interactive messaging system 200 may send a notification to client 302 indicating successful or failed transaction.

In an embodiment of the invention, the biometric engine 100 supports multimodal 310 operation, in which case, client 302 may include commercially available biometric input and capture devices, such as, but not limited to a digital camera for capturing facial images, a fingerprint scanner, a microphone for capturing voice, and an iris image capture device. Capture devices generally may include 2D face, 3D face, hand geometry, single fingerprint, ten finger live scan, iris, palm, full hand, signature, ear, finger vein, retina, DNA and voice capture devices, among others.

When the interactive messaging system 200 receives and distributes different modalities of biometric probes such as face, fingerprint, iris, a voice, among others, query engine 104 in conjunction with template data manager analyzes and converts these biometric probes into corresponding biometric templates for matching against stored biometric templates in biometric data cache 106. Matching results in individual scores for each type of biometric template being compared. Subsequently, these biometric scores generated for the different modalities of biometric probes may be combined into a single fusion biometric score, where biometric engine 100 may then return said fusion biometric score to the interactive messaging system 200 to authorize or deny transaction to client 302.

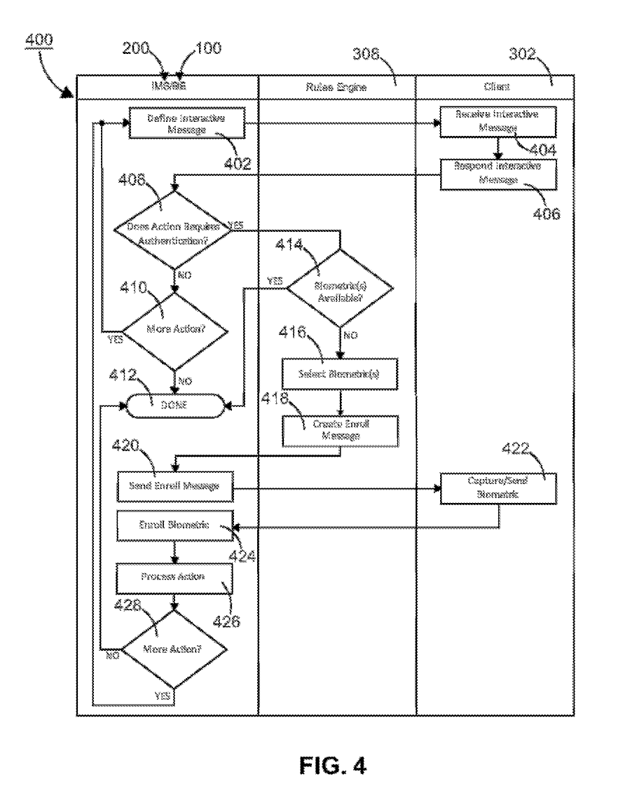

FIG. 4 illustrates an enrollment process 400 according to an embodiment of the invention. The process 400 is implemented by the integrated system 300. Enrollment process 400 starts at block 402, when the interactive messaging system 200 defines an interactive message according to a request from client application server 304. In an optional embodiment of the invention, this interactive message is generated from a pre-formed template that may contain a list of options available in the interactive messaging system 200, for example, necessary for obtaining a confirmation or authorization of the action requested by a particular client 302. Subsequently, application framework 202 in the interactive messaging system 200 sends or pushes the interactive message to client 302 via network connection 108. Client 302 receives this interactive message through a computing device, where one or more questions and corresponding action options may be displayed on the client 302 device, at block 404. Client 302 sends a response back to the interactive messaging system 200, at block 406, where such response performs an initial action from the list of options available in the interactive message.

Following the enrollment process 400, at block 408, the interactive messaging system 200 determines if the action requires authentication to confirm or authorize initial action selected by client 302. If the action does not require authentication at block 408, the interactive messaging system 200 continues and performs a check for any additional action that may be required, at block 410. If additional action is necessary, the process returns to the definition of the interactive message, at block 402, where additional action options may be included as required by the application. This portion of the enrollment process 400 continues as long as interactive message entails additional action or does not require biometric authentication. If no additional action is required, enrollment process 400 concludes, at block 412.

If biometric authentication is required, at block 408, for authorizing or confirming the action selected by client 302, then rules engine 308, in communication with the interactive messaging system 200 and biometric engine 100, checks availability and type of biometric templates stored in data caches 106, at block 414.

If biometric templates are available for that particular client 302, enrollment process 400 continues at block 410, where the process finalizes or may recycle as described above. Conversely, if biometric templates are not available for that particular client 302, then enrollment process 400 continues at block 416, where rules engine 308 selects one or more types of biometrics to be enrolled according to the capabilities of client 302 device. Specifically, rules engine 308 determines if client 302 device supports biometrics capturing; and/or if the device provides biometric templates within certain quality thresholds; and/or if environmental or situational conditions are good enough for capturing biometric probes. Thereafter, at block 418, rules engine 308 requests the creation of an enroll message to the interactive messaging system 200 with a list of biometrics required for client 302. Subsequently, the interactive messaging system 200 formulates and sends another interactive message to client 302 requesting enrollment of corresponding biometrics, at block 420.

After receiving the interactive message requesting biometrics enrollment, client 302 captures and sends corresponding biometric probes using his/her computing device, at block 422. The interactive messaging system 200 receives these biometric probes and sends them to biometric engine 100 for enrollment. The interactive messaging system 200 associates the captured biometric probes with client 302 profile stored in database 214, while biometric engine 100 converts the biometric probes into corresponding biometric templates, which are stored in one or more data caches 106, at block 424.

With enrolled biometrics available in biometric engine 100, the interactive messaging system 200 continues and processes the action requested by client 302, at block 426. The interactive messaging system 200 performs another check for any additional action that may be required, at block 428. If additional action is required, the process returns to the definition of the interactive message, at block 402, where additional action options may be included as required by the application. Otherwise, enrollment process 400 concludes, at block 412.

### Enrollment Example

As an example, an enrollment process can be performed by the integrated system 300 to access an e-learning portal. Client 302 can be a student that attends an online course at the e-learning portal and client application server 304 corresponds to infrastructure belonging to the e-learning portal that is being used by this student.

Normally, client 302 accesses his/her online course using username and password credentials. However, one day, client 302 attempts to access the online course through a smartphone, but she/he may not have access due to a new security policy that has been applied in the client application server 304. This new security policy covers the implementation of biometric authentication within the interactive messaging system 200 for protecting the user's identity and enhancing security.

Client application server 304 requests a formulation of an interactive message to the interactive messaging system 200. Then, the interactive messaging system 200 sends this interactive message to client 302. The interactive message notifies client 302 about the new security policy that has been applied and that it is required to store biometrics probes related to his/her profile for a future log in session in the e-learning portal. This interactive message may provide options of “Proceed” or “Cancel” to let the client choose his/her preferred option. Subsequently, client 302 receives the interactive message and selects an action from the options provided.

If client 302 selects “Cancel,” client 302 exits the e-learning portal. If client 302 selects “Proceed,” the interactive messaging system 200 processes the response from client 302 and notifies rules engine 308 to select one or more types of biometrics to be enrolled. Rules engine 308 may determine if the device that is being used by client 302 provides situational support, in others words, if it is capable of capturing biometric probes within specific modalities and quality thresholds. If the client 302 device is capable of capturing required biometric probes, the interactive messaging system 200 sends another interactive message to client 302 requesting the capturing of said biometric probes. In this case, the interactive messaging system 200 in conjunction with rules engine 308, may have determined that client 302 is using his/her smartphone, and may consequently request capturing of voice as biometric probe. Optionally, as a second biometric probe, the interactive messaging system 200 may request capturing of face.

After client 302 receives the second interactive message, client 302 captures his/her voice and subsequently sends corresponding biometric probe to the interactive messaging system 200. The interactive messaging system 200 associates the captured biometric probe(s) with client 302 profile stored in database 214, while biometric engine 100 converts the biometric probe(s) into corresponding biometric template(s), which can be stored in one or more data caches 106.

Finally, when biometrics are available in biometric engine 100, client 302 in his/her next log in session, may send his/her biometric probe to be verified or identified against stored templates, thereby, allowing access to the online course.

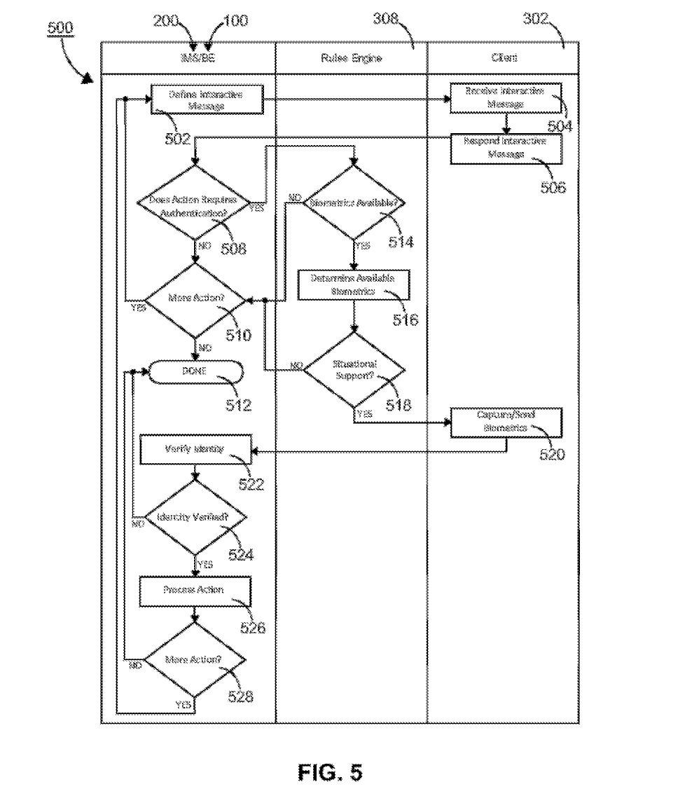

FIG. 5 illustrates a verification process 500 according to an embodiment of the invention. Verification process 400 is implemented by the integrated system 300. Verification process 500 starts when the interactive messaging system 200 alone or in conjunction with client application server 304 define an interactive message by filling in a pre-formed template, which may include one or more options for action, at block 502. In another embodiment of the invention, the definition of this interactive message is initiated by the client 302 in communication with the interactive messaging system 200 according to an embodiment of the invention.

Following verification process 500, at block 504, client 302 receives the interactive message, where a screen with one or more questions and corresponding action options are displayed on the client 302 device. Subsequently, client 302 selects an action and sends the response to the interactive messaging system 200, at block 506. The interactive messaging system 200 then checks if the selected action requires biometric authentication, at block 508. If no biometric authentication is required, the interactive messaging system 200 continues and performs a check for any additional action that is required, at block 510. If additional action is necessary, the process returns to the definition of the interactive message, at block 502, where additional action options may be included as required by the application. This portion of the verification process 500 continues as long as interactive message entails additional action or does not require biometric authentication. If no additional action is required, verification process 500 concludes, at block 512.

If biometric authentication is required, at block 508, for authorizing or confirming the action selected by client 302; then rules engine 308, in communication with the interactive messaging system 200 and biometric engine 100, checks availability and type of biometric templates stored in data caches 106, at block 514. If no biometric templates are available for that particular client 302, verification process 500 may continue at block 510, where the process finalizes or recycles as described above. On the contrary, if biometric templates are available for that particular client 302, then rules engine 308 determines one or more biometric templates stored in data caches 106 suitable for authenticating client 302, at block 516. Subsequently, rules engine 308 checks for situational support, at block 518, in other words, rules engine 308 determines if client 302 device supports biometrics capturing; and/or if the device provides biometric templates within certain quality thresholds; and/or if environmental or situational conditions are good enough for capturing biometric probes. Environmental or situational conditions can include weather, scheduling, or any other condition such as light and sound/noise levels, among others.

If situational support is not provided, rules engine 308 directs verification process 500 to the checking of additional actions, at block 510, where the process finalizes or recycles as described above. Conversely, if situational support is provided, rules engine 308 in conjunction with the interactive messaging system 200 sends another interactive message to client 302 requesting the capturing of suitable biometric templates. Optionally, this interactive message includes action options for capturing biometric probes different from the modalities determined by rules engine 308. At block 520, client 302 captures and sends suitable biometric probes to the interactive messaging system 200, which subsequently submits those biometric probes to biometric engine 100 for verification, at block 522. Optionally, client 302 sends suitable biometric probes directly to biometric engine 100.

Biometric probes submitted by client 302 can be converted into corresponding biometric templates for matching against biometric templates stored in biometric data caches 106. The result of this matching process is a biometric score which may represent a probability that the captured biometric probe is from the same client 302 as the biometric template it is being compared against. At block 524, the generated biometric score may be checked against a predetermined minimum threshold. If a successful match occurs, the interactive messaging system 200 subsequently processes or authorizes the action selected by client 302, at block 526. In the opposite scenario, if biometric score does not match minimum threshold, the interactive messaging system 200 denies action to client 302, and consequently, verification process 500 concludes, at block 512. Optionally, the interactive messaging system 200 sends a notification to client 302 indicating successful verification and action confirmation; or in case of failed verification, the interactive messaging system 200 sends another interactive message to client 302 requesting to try again or repeat the process.

After successful verification and processing of action at blocks 524, 526, the interactive messaging system 200 performs another check for any additional action that may be required, at block 528. If additional action is required, the process returns to the definition of the interactive message, at block 502, where additional action options may be included as required by the application. Otherwise, verification process 500 concludes, at block 512.

### Verification Example

As an example, verification is performed by the integrated system 300 for authorizing a financial transaction. Client 302 is an individual having vacations abroad and who recently purchased an item using his/her credit card. Client application server 304 corresponds to infrastructure belonging to a financial entity. Client application server 304 requests the formulation of an interactive message to the interactive messaging system 200, where this interactive message notifies client 302 about the recent purchase and may also provide one or more action options for authorizing said transaction. Client 302 receives this interactive message and may select the “Yes” action from the options provided. The interactive messaging system 200 then determines if biometric authentication is required for authorizing or confirming the “Yes” action selected by client 302. If client 302 selects the “No” action from the options provided, verification process ends and the transaction is denied.

If biometric authentication is required for processing the selected “Yes” action, rules engine 308 determines the biometric templates available for that particular client 302 in biometric engine 100, while also determining if the device that is being used by client 302 provides situational support, in others words, if it is capable of capturing biometric probes within specific modalities and quality thresholds. If the client 302 device is capable of capturing required biometric probes, the interactive messaging system 200 sends another interactive message to client 302 requesting the capturing of said biometric probes. In this case, the interactive messaging system 200 in conjunction with rules engine 308 may have determined that client 302 is using his/her smartphone, and may consequently request capturing of voice as biometric probe. Optionally, as a second biometric probe, the interactive messaging system 200 may request capturing of face.

Client 302 captures his/her voice and subsequently sends corresponding biometric probe to the interactive messaging system 200 which sends the captured biometric probes to biometric engine 100 for verification. If a successful verification is obtained, biometric engine 100 notifies the interactive messaging system 200, which subsequently authorizes the transaction and notifies the client 302. If a failed verification is obtained, biometric engine 100 notifies the interactive messaging system 200, which denies the transaction and notifies the client 302. Optionally, the interactive messaging system 200 sends another interactive message, which may include additional action options for either scenario of successful or failed verification, in which case, client 302 may opt to select additional actions to continue or end verification process 400.

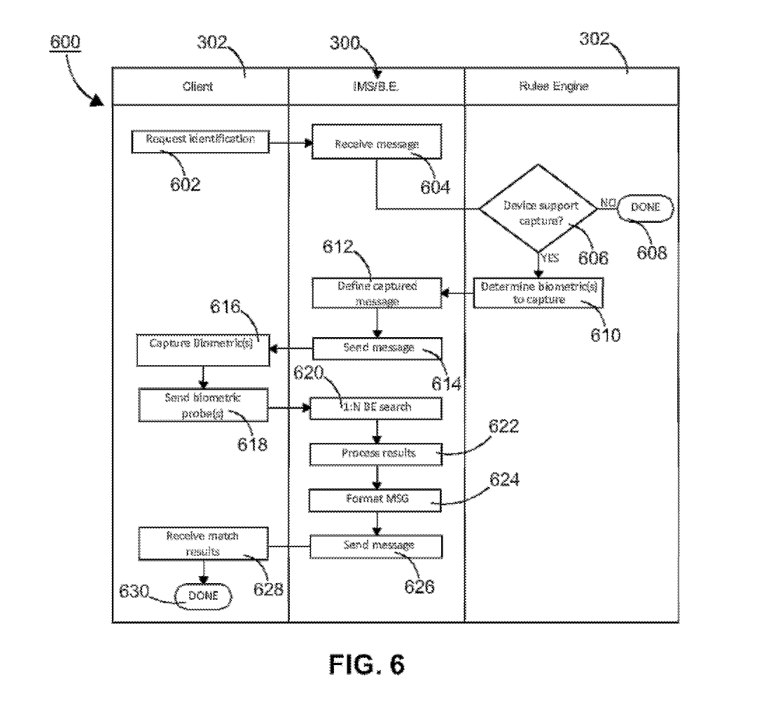

FIG. 6 illustrates an identification process 600 according to an embodiment of the invention. The identification process 600 is performed by integrated system 300. Identification process 600 initiates at block 602, when client 302 requests a biometric identification of an individual among a determined population. The interactive messaging system 200 receives this request for biometric identification and subsequently establishes communication with rules engine 308, at block 604. Rules engine 308 checks if the computing device used by client 302 supports biometric capturing of biometric probes, at block 606.

If the computing device of client 302 cannot support biometric capturing, the identification process 600 finalizes, at block 608. Conversely, if the computing device of client 302 supports biometric capturing of biometric probes, rules engine 308 selects one or more types of biometrics to be captured, according to capabilities of client 302 device, at block 610. Specifically, rules engine 308 determines if client 302 supports biometrics capturing; and/or if the device provides biometric templates within certain quality thresholds; and/or if environmental or situational conditions are good enough for capturing biometric probes.

Following with the identification process 600, the interactive messaging system 200 defines an interactive message requesting biometric capturing of the biometrics selected by rules engine 308, at block 612. This interactive message is then sent to client 302, at block 614. Subsequently, client 302 captures the corresponding biometrics of the individual that requires to be identified, using his/her computing device, at block 616. These biometric probes are then be sent to the interactive messaging system 200; whereupon the interactive messaging system 200 sends these biometric probes to biometric engine 100 to identify the identity of the individual, at block 618.

Afterwards, at block 620, biometric engine 100 receives biometric probes sent by client 302 to be associated and compared against biometric templates stored in data cache 106. Here, biometric engine 100 identifies the type of each biometric probe to be compared against corresponding data caches 106. During this comparison process, at least one or more candidates from at least one biometric data cache 106 might match at least one previously enrolled biometric template, whereupon the match result generates at least one score. Therefore, at block 622, biometric engine 100 determines if one or more of the biometric scores generated meet a minimum threshold score. If it is determined that one or more biometric scores meet the minimum threshold score, then at least one score is added into a list of possible matches. Conversely, if generated biometric scores do not meet minimum threshold score, then biometric engine 100 moves on to the next candidate. The comparison process cycles until determining if there are no more candidates to compare.

Continuing the identification process 600 in integrated system 300, biometric engine 100 returns a list of matches, comprising biometric scores associated with identification credentials of the individual, wherein biometric engine 100 sorts the list of matches by the probability of identity. Biometric engine 100 can also limit the length of the list of matches according to a list threshold.

Consequently, the interactive messaging system 200 formats and sends another interactive message with the list of matches from biometric engine 100, at block 624 and block 626 respectively. Finally, client 302 receives the interactive message with the match results at block 628, where the identification process 600 ends at block 630.

### Identification Example

As an example, an identification process is performed by integrated system 300 in a law enforcement and public safety agency. Client 302 can be a police officer that utilizes a computing device such as a tablet computer to access an application owned or operated by the agency. Through this application, client 302 submits and sends a request to interactive messaging system 200 requesting the identity identification of the detained suspect. Rules engine 308 verifies if the tablet computer that is being used by client 302, supports biometric capturing of biometric probes. If the tablet computer does not support biometric capturing, the request may not be successful, in which case, the identification process may finalize. If the tablet computer supports biometric capturing, the identification process continues with rules engine 308 determining the type of biometric probes supported by the tablet computer.

Following the process, an interactive message formulated by the interactive messaging system 200 is sent to client 302, requesting the biometric capturing of one or more biometric probes of the suspected individual. Such biometric probes can be fingerprint, voice and face. Subsequently, client 302 submits the captured biometric probes to the interactive messaging system 200.

The interactive messaging system 200 sends these biometric probes to biometric engine 100 to compare and associate against previously enrolled templates stored in data cache 106. Biometric engine 100 identifies the type of biometric probes to be compared against the corresponding data cache 106 within previously enrolled biometric templates related to fingerprints, voice and face. A certain number of candidates can be related with biometric templates stored in data cache 106. In this case, comparison is performed for voice and face templates which are already stored in data cache 106 for that particular suspect. Biometric engine 100 generates at least two different scores, which are checked against a minimum threshold score. In this example, the face score does not meet the minimum threshold score, while the voice score successfully meets the minimum threshold.

Subsequently, biometric engine 100 generates a list matches comprising the voice score associated with possible identification credentials, where biometric engine 100 sorts this list of matches by probability of identity of the suspected individual. Thereupon, the interactive messaging system 200 formats and sends another interactive message with the top 3 matches from biometric engine 100 to client 302. In this example, the top 3 matches can include a photo and name of 3 individuals. Finally, client 302 receives the interactive message with the identification results and recognizes the identity of the suspected individual.

One of ordinary skill in the art appreciates that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular constraints imposed on the overall system Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, or block without departing from the invention.

The various illustrative logical blocks, units, steps and modules described in connection with the embodiments disclosed herein, and those provided in the accompanying documents, can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC. Additionally, device, blocks, or modules that are described as coupled may be coupled via intermediary device, blocks, or modules. Similarly, a first device may be described a transmitting data to (or receiving from) a second device when there are intermediary devices that couple the first and second device and also when the first device is unaware of the ultimate destination of the data.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein.

I claim:

1. An integrated interactive messaging system comprising:
an interactive messaging server configured to communicate interactive messages to a client device used by a user; and
a biometric engine to enroll, authenticate, or identify the user via one or more biometrics captured at the client device.

2. The system of claim 1, wherein the one or more biometrics are two or more different biometrics.

3. The system of claim 2, wherein the biometric engine comprises a query router and two or more query engines, each query engine dedicated to one of the two or more different biometrics.

4. The system of claim 3, wherein the query router is configured to receive a request from the interactive messaging server to authenticate or identify the user and a first biometric probe and a second biometric probe, route the first biometric probe to a first query engine of the two or more query engines, and route the second biometric probe to a second query engine of the two or more query engines.

5. The system of claim 4, wherein the query router is configured to receive a response from the first query engine and a response from the second query engine, wherein the response from the first query engine comprises an indication that authentication or identification of the first biometric probe was successful or unsuccessful, and the response from the second query engine comprises an indication that authentication or identification of the second biometric probe was successful or unsuccessful.

6. The system of claim 5, wherein the query router is configured to send a response to the interactive messaging server, the response to the interactive messaging server comprising an indication that authentication or identification of the user was successful or unsuccessful.

7. The system of claim 5, wherein the query router is configured to send a response to the interactive messaging server, the response to the interactive messaging server comprising one or more biometric scores.

8. The system of claim 5, wherein the query router is configured to send a response to the interactive messaging server, the response to the interactive messaging server comprising a biometric fusion score.

9. The system of claim 4, wherein the request from the interactive messaging server to authenticate or identify the user is a service-oriented architecture (SOA) call.

10. The system of claim 3, wherein the biometric engine comprises a first biometric data cache and a second biometric data cache, the first biometric data cache comprising a set of biometric templates of a first biometric type, the second biometric data cache comprising a set of biometric templates of a second biometric type, and the biometric engine is configured to never send the set of biometric templates of a first biometric type and the set of biometric templates of a second biometric type to the interactive messaging server.

11. An integrated interactive messaging method, the method implemented at an interactive messaging server and comprising:
communicating one or more interactive messages to a client device used by a user; and
receiving one or more biometrics captured at the client device.

12. The method of claim 11, wherein the one or more biometrics are two or more different biometrics.

13. The method of claim 11, further comprising sending a request to authenticate or identify the user and a first biometric probe and a second biometric probe to a biometric engine.

14. The method of claim 13, further comprising receiving a response from the biometric engine indicating that authentication or identification of the user was successful or unsuccessful.

15. The method of claim 14, the response comprising one or more biometric scores or a biometric fusion score.
